(19) United States
(12) Patent Application Publication
(10) Pub. No.: US 2006/0096121 A1
(43) Pub. Date: May 11, 2006

(54) Ink drying device of web offset press

(75) Inventor: Junzo Nagashima, Tokyo (JP)

Correspondence Address: YOUNG & THOMPSON, 745 SOUTH 23RD STREET, 2ND FLOOR, ARLINGTON, VA, 22202, US

(73) Assignee: YUGEN KAISHA ADVANCED ENGINEERING, TOKYO (JP)

(21) Appl. No.: 10/981,658

(22) Filed: Nov. 5, 2004

(51) Int. Cl. F26B 3/00; F26B 9/00

(52) U.S. Cl. 34/618; 34/444

(57) ABSTRACT

In an web offset press an ink adhering on a surface of a printed paper is dried during passing through a drying section of an ink drying device. The drying section is provided with an inlet through which the printed paper is guided into the drying section and an outlet through which the printed paper is discharged therefrom. The ink drying device includes a hot air supply unit for supplying a hot air to a portion near the outlet of the drying section, and a hot air blow-back unit for blowing back a solvent vapor remaining and staying around the printed paper surface into the drying section.

### BACKGROUND OF THE INENTION

1. Field of The Invention

The present invention relates to an ink drying device or ink drier of an web offset press.

2. Related Art

An web offset press is generally equipped with an ink drying device as an ink drier for drying an ink printed on a web, which is disclosed in, for example, Japanese Patent Unexamined Publication No. 2002-234135.

FIGS. 3 and 4 shows an web offset press is provided with an ink drying device 3 for drying an ink printed on both surfaces of a printed (printing) paper 1 as a web which is printed by a printing device 2, and the printing paper 1 introduced in the drying device 3 is dried by blowing hot air of a heating temperature of, for example, 160 degree centigrade through a nozzle. The ink printed on the printing paper 1 is thermally polymerized by this hot air.

As shown in FIG. 3, the printed paper 1 subjected to the hot air blowing is fed from the ink drying device 3 towards a cooling device 4 in which the hot air contacts a cooling roller 5 called chill roll. The ink, which is heated by the hot air and is now being thermally polymerized, is then rapidly cooled in contact to the cooling roller 5 and fixed to the printed paper 1. That is, the ink is dried and fixed to the paper surface.

During the above process, however, the printed paper 1 travels at a high speed of about 6 to 9 m/sec in the ink drying device 3 and, in this high speed travelling, a solvent contained in the ink as an ink component is evaporated as a solvent vapour on the surface of the printed paper 1. Accordingly, as shown in FIGS. 4 and 5, the printed paper 1 is fed towards the cooling roller 5 in a state that evaporated solvent vapour 6 clings to the paper surface of the printed paper 1 and then rapidly cooled. Because of this reason, the solvent vapour 6 is rapidly cooled and condensed, which adheres or sticks, as liquid-state solvent 7, on the surface of the cooling roller 5. The liquid-state solvent 7 adhering on the surface of the cooling roller 5 then adheres to the printed paper surface in a state such as shown in FIG. 6, and the liquid-state solvent 7 adhering on the paper surface dissolves the ink 1a on the paper surface, which may adversely results in ink squeeze out of printed image 8 printed by the ink 1a on the printed paper 1, and moreover, the dissolved ink 1a and the solvent 7 spoiled by this dissolved ink 1a contaminate printed image 8 printed on the paper surfaces, thus being inconvenient and defective.

As mentioned above, the solvent adhering and staying on the surface of the cooling roller 5 deteriorates the quality of a printed material or product, and in order to obviate such defect, in a prior art, the surface of the cooling roller 5 is periodically swept and cleaned by using a specific cleaning device. However, even if such cleaning be performed, there still remains a case that the solvent may stay on the roller surface depending on concentration of the ink of printed image 8, quality of the printing paper 1 or like and the staying solvent may cause a contaminated printed state. Furthermore, at the time of cleaning the surface of the cooling roller 5, the printing press is generally stopped in its operation, and therefore, the condensation of the solvent on the cooling roller surface may result in a cause of lowering of printing efficiency.

FIG. 7 shows an ink drying device of a conventional structure. The ink drying device 3a shown in FIG. 7 is provided with a drying chamber 12 for drying an ink adhering on the printed (printing) surface during the passing of the printed paper 1 in this drying chamber 12. In the ink drying chamber 12, there are arranged hot air nozzles 14 for jetting (blowing) the hot air 13 towards the printed surface to dry the ink 1a.

The ink drying device 3a is provided, at predetermined appropriate portions, with an inlet 15 for introducing the printing paper 1 into the ink drying chamber 12 and an outlet 16 through which the printed paper 1 is discharged out of the drying chamber 12.

FIG. 7 includes FIG. 7A as an encircled portion in an enlarged scale, and as shown in FIG. 7A, when such drying device 3a is used, outside air, as cold air, 17 is introduced into the drying chamber 12 at portions near the inlet 15 and outlet 16, and therefore, the surfaces of the nozzles 14 and structural portions or parts including wall section of the drying chamber 12 near the inlet 15 and the outlet 16 of the drying chamber 12 are cooled, as well as the solvent vapour staying on the printed paper 1 is also cooled and condensed thereon. The cooled solvent 7 will be precipitated on the surfaces of the nozzles 14 or portions near, thus being inconvenient and troublesome for operation.

In order to prevent the condensation of the solvent, as shown in FIG. 7B, there is provided a technique for cutting off, by using an air-knife nozzle 18, the remaining solvent vapour 6 discharged from the ink drying device 3a while clinging to the surface of the printed paper 1, before reaching the cooling roller 5. In this technique, however, the air-knife nozzle 18 blows air of room temperature, and the portion near the outlet of the ink drying device 3a is cooled. This will result in the precipitation of the solvent on the surface of the air-knife nozzle 18 and the portion near the outlet of the ink drying device 3a, thus providing an undesired state.

### SUMMARY OF THE INVENTION

The present invention was conceived in consideration of the defects or inconveniences encountered in the prior art mentioned above and an object of the present invention is therefore to provide an ink drying device of an web offset press capable of keeping a temperature at inlet and outlet portions of the ink drying device for a printing paper to a temperature more than predetermined one.

This and other objects of the present invention can be achieved by providing, in one aspect, an ink drying device of an web offset press comprising:

a drying section for drying an ink adhering on a surface of a printed paper, in which the ink adhering on the printed paper surface is dried during passing through the drying section, said drying section being provided with an inlet through which the printed paper is guided into the drying section and an outlet through which the printed paper is discharged therefrom;

a hot air supply unit for supplying a hot air to a portion near the outlet of the drying section; and

a hot air blow-back unit for blowing back a solvent vapor remaining and staying around the printed paper surface into the drying section.

In preferred embodiments in this aspect, the ink drying device may further includes a treating section, and the hot air to be supplied to the blow-back unit is an exhaust air which is cleaned by the treating section after being used for drying the ink in the drying section.

The ink drying device may also includes a temperature control unit for regulating a temperature of the hot air to be supplied to the blow-back unit.

The ink drying device may also includes a hot air supply unit for supplying the hot air to portions near an inlet opening and an outlet opening provided for the ink drying device through which the printed paper introduced into and discharged from the drying section so as to keep temperatures at the portions near the inlet and outlet openings to a temperature more than a predetermined value.

The ink drying device may be provided with a chamber mounted to a wall structure of the ink drying device, and the inlet of the drying section corresponds to the inlet opening provided for the ink drying device and the outlet opening is formed to the chamber so as to communicate with the outlet of the drying section formed to the wall structure of the ink drying device. The hot air blow-back unit is disposed in the chamber, and the hot air blow-back unit may comprise an air-knife nozzle fixed to an inside of the chamber.

In another aspect of the present invention, there is provided an ink drying device of an web offset press comprising:

a drying section for drying an ink adhering on a surface of a printed paper, in which the ink adhering on the printed paper surface is dried during passing through the drying section, said drying section being provided with an inlet through which the printed paper is guided into the drying section and an outlet through which the printed paper is discharged therefrom;

a burning section disposed above the drying section through a partition wall for generating a hot air for drying the printed paper;

a treating section disposed above the burning section through a partition wall for cleaning the hot air;

an inlet through which the printed paper is guided into the drying section;

an outlet through which the printed paper, which is dried in the drying section, is discharged therefrom;

a hot air supply unit for supplying the hot air to portions near the inlet and outlet for the printed paper so as to keep temperatures around the inlet and outlet to temperatures more than predetermined valves; and

a hot air blow-back unit for supplying the hot air at the portions near the inlet and outlet so as to blow back solvent vapor remaining and staying around the printed paper surface into the drying section, wherein the temperatures at the portions near the inlet and outlet is kept, by the hot air supplied by the hot air supply unit, to temperatures more than lower limit temperature for precipitation of the remaining solvent vapor on the printed paper surface.

According to the above aspect of the present invention, the following advantageous functions and effects can be attained.

In a conventional art, the solvent vapor remaining and staying around the printed paper surface is rapidly cooled by the cooling roller at the time of advancing to the next process and precipitated on the printed paper surface. However, according to the present invention, since the solvent vapor remaining and staying around the printed paper surface can be blown back into the drying section, so that the contamination of the printed paper surface by the remaining solvent vapor can be effectively prevented.

Furthermore, since the hot air used in the drying section is discharged into the atmosphere, and a portion of the exhaust air is again returned, after burning and cleaning the air to remove impurity and like, to the drying section to thereby suppress a creation of saturated state of the solvent vapor.

Still furthermore, the hot air can be supplied at a regulated desired temperature. In addition, since the temperatures at the portions near the paper inlet and outlet portions can be maintained to temperatures more than the predetermined values. Thus, it is possible to prevent the solvent vapor from precipitating at a temperature of less than the lower limit temperature of liquefaction of the solvent vapor by an intake cold air and to prevent the printed paper from contaminating by the precipitated solvent dropping on the printed paper surface.

The mature and further characteristic features of the present invention will be made more clear from the following descriptions made with reference to the accompanying drawings.

### BRIEF DESCRIPTION OF THE DRAWINGS

In the accompanying drawings:

FIG. 1 is a vertical section of an ink drying device of an web offset press according to the present invention;

FIG. 2 shows an essential portion of the ink drying device of the present invention as viewed from a downstream side in a feeding direction of a printing paper, in which FIG. 2A shows an operating state and FIG. 2B shows an operation stopping state;

FIG. 3 is a schematic front view of a general web offset press to which the present invention is applicable;

FIG. 4 is a schematic diagram showing an ink drying device of conventional structure;

FIG. 5 is an illustration showing a state of solvent vapour dewing on a cooling roller;

FIG. 6 is an illustration showing a state that the solvent dewed on the cooling roller surface adheres on the printing paper surface; and

FIG. 7 shows an ink drying device of a conventional structure in which FIG. 7A shows a vertical section of a drying portion in the ink drying device and FIG. 7B is an illustration showing a state that the solvent dewed on a blowing nozzle adheres on the printed paper surface.

### DESCRIPTION OF THE PREFERRED EMBODIMENT

A preferred embodiment of an ink drying device according to the present invention will be described hereunder with reference to the accompanying drawings.

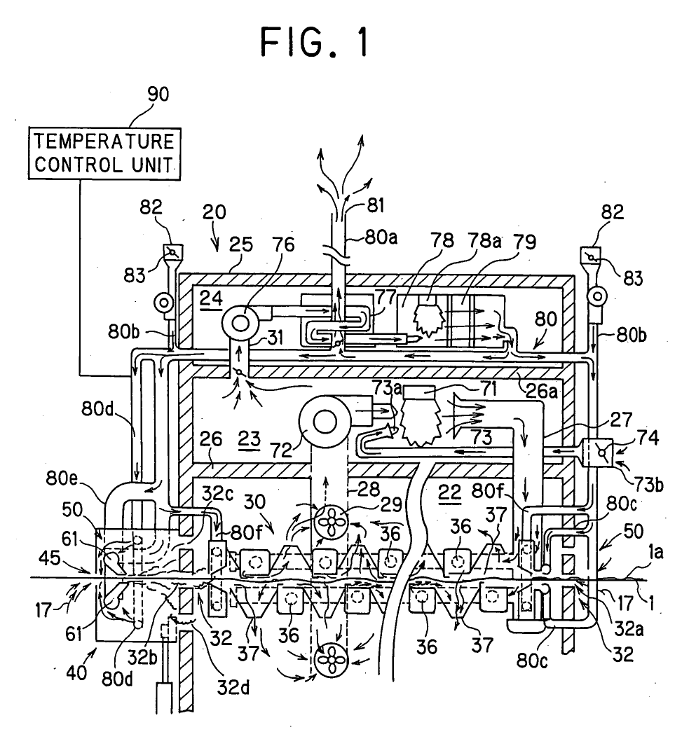

The ink drying device of the present invention is arranged in, for example, the web offset press shown in FIG. 1 in substitution for the conventional ink drying device 3.

This web offset press is provided with a paper feeding device 9, a printing device 2, an ink drying device 20 in place of the conventional ink drying device 3, a cooling device 4 and a paper folding device 21 in the described order along the feeding direction of a printing (printed) paper 1 as a web.

The printing paper 1 fed from a roll-up paper 9a in the paper feeding device 9 is subjected to multi-color printing with a plurality of color inks to its front and rear surfaces during the passing in respective units in the printing device or section 2 and then the inks are dried by the ink drying device 20, which will be described in detail hereinafter, and cooled by a plurality of cooling rollers 5 arranged in the cooling device 4. Thereafter, the printed paper 1 is folded and then cut in a desired shape by the paper folding device 21.

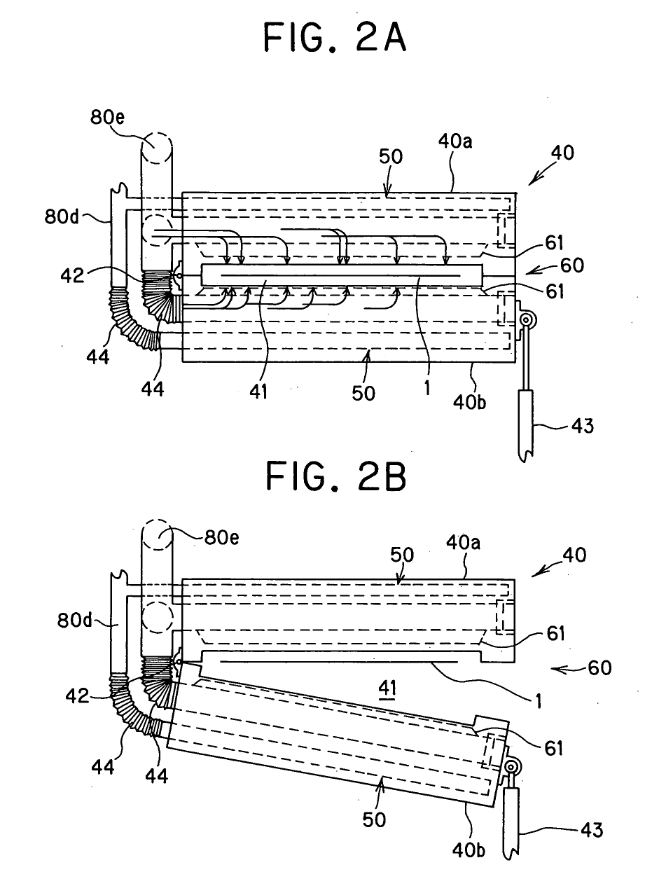

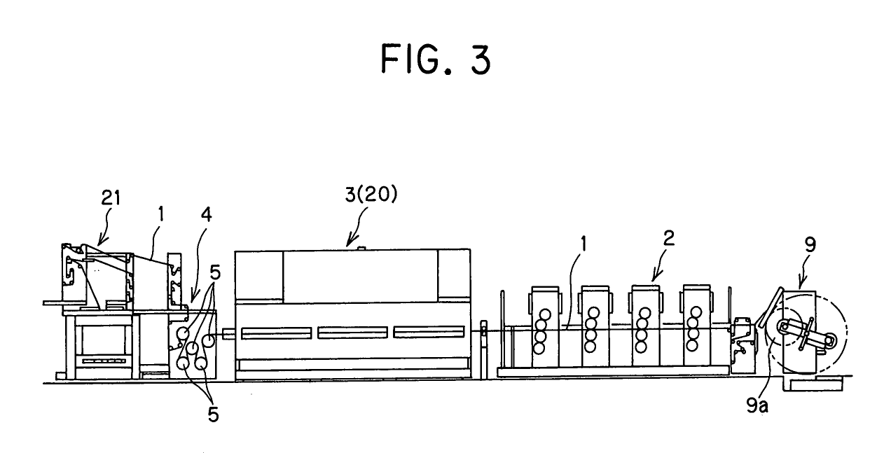

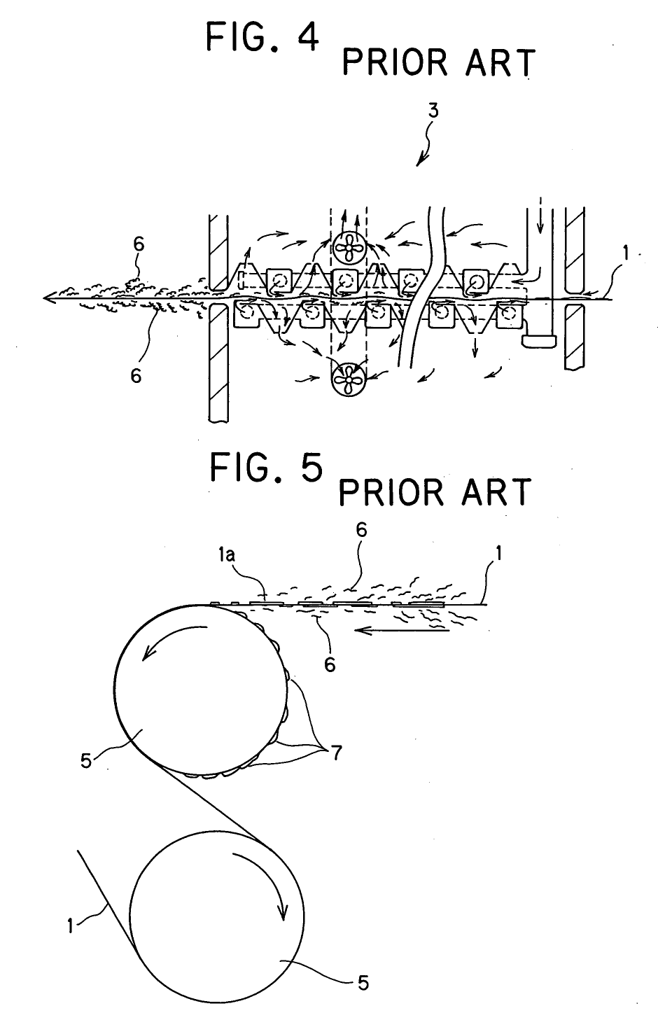

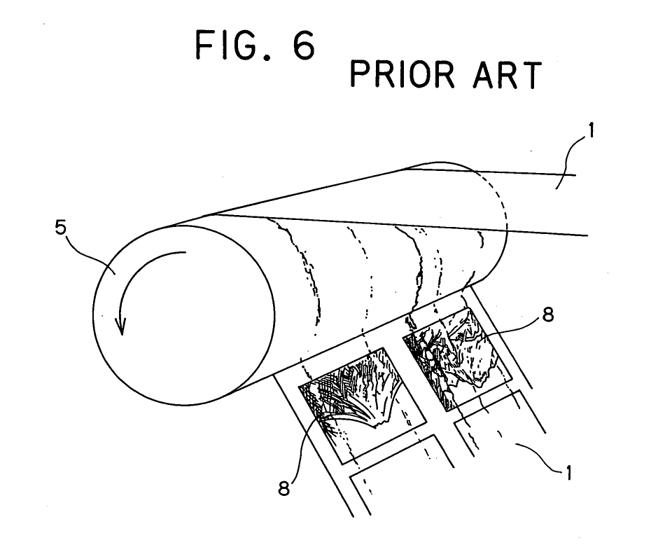

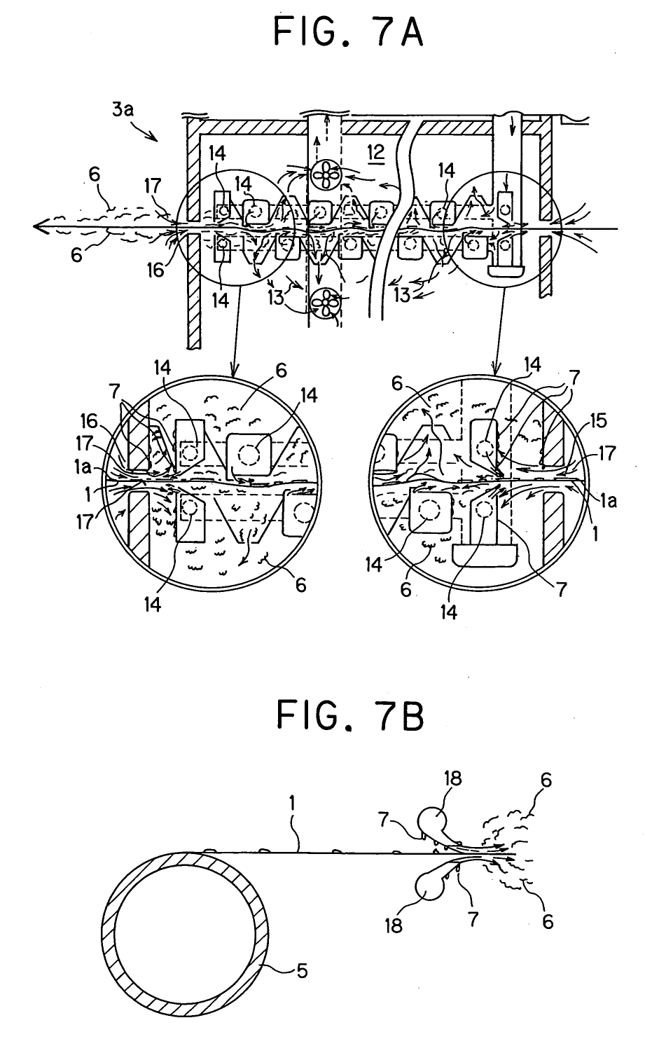

Herein, since the paper feeding device 9, the printing device 2, the cooling device 4 and the paper folding device 21 of the web offset press mentioned above have known structures, the details thereof are not described, and the ink drying device 20 according to the present invention will be described in detail hereunder with reference to FIGS. 1 and 2.

As shown in FIG. 1, the ink drying device 20 is provided with a drying section 22 serving as a driving chamber for drying the ink printed on the printing (printed) paper 1 passing through the printing device 2, a burning section 23 serving as a burning or combustion chamber for generating hot air for drying the ink on the printed surface of the paper or web 1, and a treating section 24 as a treating chamber for cleaning the hot air, these sections being arranged in vertical stages as shown.

These drying section 22, burning section 23 and treating section 24 are surrounded by a wall structure 25 and sectioned inside the wall structure 25 by means of partitions 26 and 26a, respectively.

The drying section 22 and the burning section 23 are communicated with each other through a hot air supply tube 27 for supplying the hot air into the drying section 22 and an exhaust tube 28 for discharging air in the drying section 22 to the burning section 23. The supply tube 27 has one end connected to a hot air supplying unit 30 for supplying the hot air to dry the ink 1a adhering on the printed surface. The exhaust tube 28 is equipped with an exhaust fan 29 for discharging the air inside the drying section 22.

On the other hand, the burning section 23 and the treating section 24 are communicated with each other through an exhaust tube 31 for discharging air inside the burning section 23.

The printed paper 1 passing through the printing device 2 is introduced in the drying section 22 of the drying device 20 and discharged therefrom through openings 32 formed to the wall structure 25 defining the drying section 22. These openings 32 includes an opening serving as an inlet 32a through which the printed paper 1 is introduced in the drying section 22 and an opening serving as an outlet 32b through which the printed paper 1, which has been dried, is discharged.

Furthermore, the drying section 22 is provided with the hot air supplying unit 30 for supplying the hot air for drying the ink 1a adhering on the front and rear (back) surfaces of the printed paper 1 to thereby dry the ink 1a and another hot air supplying unit 35, disposed to a portion near the inlet 32a through which the printed paper 1 is introduced into the drying section 22, for heating cold air flowing through the opening 32, i.e., inlet 32a.

The hot air supplying unit 30 for drying the ink adhering on the surface of the printed paper is arranged so as to oppose to both the front and rear surfaces of the printed paper 1 passing through of the drying section 22 to thereby blow the hot air on both these front and rear surfaces of the printed paper 1. More specifically, as shown in FIG. 1, the hot air supplying unit 30 is composed of nozzle groups arranged in shape of matrix along the front and rear surfaces of the printed paper 1 at the drying section 22. Each nozzle group includes nozzles 36, 36, - - - , 36 and is connected, at one end thereof, to the supply tube 27 and opened at the other one end towards the front and rear surfaces of the printed paper 1.

The hot air fed from the burning section 22 blows towards the front and rear surfaces of the printed paper 1 through nozzle openings of the respective nozzles 36 by way of the supply tube 27. Openings 37, 37, - - - , 37 are formed between the respective rows of nozzles 36 so that the hot air colliding on the surfaces of the printed paper 1 is discharged into the drying section 22 through these openings 37. The hot air discharged inside the drying section 22 is partially discharged into the burning section 23 through the exhaust tube 28 by means of exhaust fan 29.

Furthermore, a chamber 40 having a predetermined inner space is formed on the wall structure 25 at a portion near the opening 32b of the drying section 22.

As shown in FIG. 2, the chamber 40 is composed of an upper chamber section 40a and a lower chamber section 40b, and an intermediate space portion 41 is formed at a central portion between these chamber sections 40a and 40b as an opening through which the printed paper passes. The upper and lower chamber sections 40a and 40b are fixed to be rotatable at one ends thereof. More specifically, both the chamber sections 40a and 40b are connected by means of hinge 42 at a portion along the one side edge of the printed paper 1 in a manner such that the upper chamber section 40a is fixed to the side wall structure 25 of the drying device 20 and the lower chamber section 40b is connected to a hydraulic cylinder device 43.

When the hydraulic cylinder device 43 is driven and the lower chamber section 40b is pivoted to be mated, with the upper chamber section 40a, the printed paper 1 is sandwiched between these upper and lower chamber sections 40a and 40b (FIG. 2A). On the contrary, as shown in FIG. 2B, when the hydraulic cylinder device 43 is driven so as to separate the lower chamber section 40b from the upper chamber section 40a, the printed paper 1 is released. According to such operation of the hydraulic cylinder device 43, the passing of the printed paper 1 through the space 41 of the chamber 40 is carried out.

Furthermore, as shown in FIGS. 1 and 2, the chamber 40 is formed with an outlet opening 45, at an end portion thereof in the paper feeding direction, through which the printed paper 1 passing through the inside thereof is discharged outside.

The drying section 22 and the central space portion 41 of the chamber 40 are communicated with each other through the opening 32b formed to the wall structure 25. The printed paper 1 passes through the space 41 and is exhausted through the opening 45 so as to be subjected to the next procedure or treatment.

A hot air supplying unit 50 is disposed at a portion near the outlet of the chamber 40 through which the paper 1 passes for supplying the hot air to heat the cold air flowing through the opening 45 of the chamber 40.

Further, openings 32c and 32d may be formed with a predetermined space in the vertical direction of the outlet 32b formed to the wall structure 25 so as to be communicated with the space 41 of the chamber 40.

Furthermore, a blow-back member 60, for blowing the remaining solvent vapour staying around the printed paper 1 back to the drying chamber, is disposed inside the chamber 40. It may be preferred that this blow-back member 60 is fixed to the inside portion of the chamber 40. Furthermore, flexible tubes 44, 44 are formed to portions of the chamber 40 to which a pipe member or piping 80 for supplying the hot air is connected, as mentioned later, so as not to obstacle the opening/closing operation of the upper and lower chamber sections 40a and 40b.

The blow-back member 60 is formed as, for example, air-knife nozzles 61, 61, each having an opening in form of slit. The air-knife nozzles 61 are arranged so as to cross the printed paper 1 in a manner opposing thereto. The air-knife nozzle 61 serving the hot-air blowing opening has a front end portion inclining from the outside of the wall structure 25 forming the drying section 22 towards the outlet 32b of the drying section 22. A plurality of these air-knives 61, 61, - - - , 61 may be arranged along the feed direction of the printed paper 1. In an alternation, a plurality of nozzles, each provided with a circular opening, may be arranged so as to cross the printed paper 1 in place of the air-knives 61 mentioned above.

As also shown in FIG. 1, the burning section 23 is arranged above the drying section 22 with the partition wall 26 being interposed. The burning section 23 is provided with a heating burner 71, an air supply fan 72 and a pipe member 73 having one end to which a burning assisting outer air supply port 73a is formed and another one end to which an outer air intake port 73b is formed. The air supply fan 72, the burning assisting outer air supply port 73a and the inlet port of the supply tube 27 face the heating burner 71. Furthermore, a damper 74 is disposed near an inner end portion of the outer air intake port 73b of the pipe member 73 for adjusting the intake air amount necessary for the burning.

The burning section 23 serves to generate a hot air by heating, to a predetermined temperature, the exhaust air discharged from the inside of the drying section 22 through the exhaust tube 28 and an air taken inside through the burning assisting outer air supply port 73a by the heating burner 71. The thus generated hot air is fed, through the hot air supply tube 27, to the respective nozzles 36 arranged vertically to the printed paper 1. The hot air jetted, at high speed, against both the front and rear (back) surfaces of the printed paper 1 from the respective nozzles 36 so as to thermally polymerize the ink adhering on the printed paper 1. The hot air after heating the ink is returned inside the burning section 23 through the exhaust tube 28 by the operation of the exhaust fan 29 as mentioned above and is again fed to the heating burner 71 by means of the air supply fan 72 so as to be reused.

On the other hand, the treating section 24 is arranged above the burning section 23 through the partition wall 26a. This treating section 24 is provided with an air feed fan 76 for feeding the air in the burning section 23 into the treating section through the exhaust tube 31, a heat exchanger 78 having a heating burner 78a for generating a hot air having a predetermined temperature, from the air taken by the air feed fan 76, through a connection pipe 77, a deodorizer 79 for deodorizing odor or impurity contained in the hot air discharged from the heat exchanger 78 and a pipe member 80 which serves to discharge the hot air cleaned by the deodorizer 79 and return a portion of the hot air to the drying section 22. That is, the hot air cleaned by the treating section 24 flows in the pipe member 80.

The pipe member 80 is divided or distributed into a plurality of pipe sections 80a, 80b, - - - , 80f, and for example, the pipe section 80a is provided with an exhaust port 81 for discharging outside the hot air. Furthermore, the pipe section 80b is provided, for example, at its end portion, with an external air intake port 82. A damper 83 is incorporated in this pipe section 82b, and the air amount to be taken is adjusted by controlling the damper 83 to thereby regulate the degree of lowering the hot air temperature.

Further, the end portions of the other pipe sections 80c, 80d, 80e and 80f are communicated with an inlet of the printed paper 1 inside the drying section 22, a portion near the outlet thereof, the air-knife nozzle 61 and the nozzle 36, respectively. In these pipe sections, the pipe section 80 having one end disposed near the outlet of the printed paper 1 is arranged so that the hot air flows towards the portion near the outlet of the printed paper 1. The pipe sections 80c and 80d serve as the hot air supplying unit 50 for supplying the hot air so as to heat the external air (cold air) fed from the inlet opening 32a and the outlet opening 45 of the printed paper 1 and then to keep the temperatures around these inlet and outlet openings 32a and 45 to temperatures more than predetermined values. The pipe section 80c is arranged at the predetermined position of the inlet and the pipe section 80d is fixed inside the chamber 40.

The ink drying device 20 is provided with a control unit 90 as a temperature controlling means, and for example, a sensor is incorporated in the pipe section 80d. This sensor operates to introduce the external air through the external air intake port 82 while controlling a damper 82 so as to control or regulate the temperature of the hot air passing through the pipe section 80d to a predetermined value and serves to control the temperature of the hot air cleaned by the treating section 24 to the predetermined value. Furthermore, other sensors are also arranged in the drying section 22 and in the chamber 40. These sensors operate to control the damper 82 so as to regulate the intake amount of the external air to keep the temperatures inside the drying section 22 and the chamber 40 to temperatures more than the lower limit temperature of precipitation of the solvent vapour, and also operate to regulate the temperatures of the hot air passing through the pipe sections 80c to 80f. Further, it is desired that the hot air has a temperature about 160 degree centigrade.

The ink drying device 20 of the structure mentioned above will be operated in the following manner.

The printed paper 1 passing through the drying section 22 then passes the space 41 between the upper and lower chamber sections 40a and 40b which are now opened as shown in FIG. 2B, and thereafter, these chamber sections 40a and 40b are closed as shown in FIG. 2A. According to this operation, the paper passing with respect to the chamber 40 and the blow-back nozzles 30a, 30a has been completed.

On the printing starting time, a hot air is generated by using the heating burner 71 at the burning section 23, and the thus generated hot air is supplied to the nozzle(s) 36 provided for the drying section 22 through the hot air supply tube 27. The hot air is jetted through the opening of the nozzle 36 to heat the ink 1a adhering on the printed paper 1 travelling at a high speed. According to this heating by the hot air, the solvent contained in the ink 1a starts to be actively evaporated and the resin in the ink 1a also starts to be thermally polymerized, thus accelerating the drying of the ink 1a.

On the other hand, the hot air colliding on the printed paper surface is recovered by the exhaust fan 29 in a state of containing the solvent vapor through the exhaust tube 28, and fed again to the heating burner 72 by means of the air supply fan 72 and heated therein. A portion of the recovered hot air is caught in the treating section 24 through the exhaust tube 31 by the air feed fan 76, in which the hot air is cleaned by the deodorizer 79 and then released into atmosphere. A portion of the hot air cleaned in the treating section 24 and then discharged therefrom is supplied to the respective pipe sections 80c to 80f after regulating its temperature to the predetermined value.

The printed paper 1 heated by the hot air passes through the outlet opening 32b of the drying section 22, through the space 41 between the chamber sections 40a and 40b and then discharged through the opening 45. The solvent vapor evaporated from the ink 1a is clung around the surface of the printed paper 1. Such solvent vapor will be blown back as a high speed jet flow to the upstream side (drying section 22) of the printed paper 1 by the portion of the exhaust hot air supplied from the treating section 22 through the air-knife nozzle 61 and the blown-back solvent vapor is returned in the drying section 22 through the outlet opening 32b together with the hot air.

According to the operation described above, the hot air is blasted or jetted on the printed paper 1 at a high speed by the blow-back means 60, i.e., air-knife nozzle(s) 61, and hence, the solvent vapor staying around the printed paper surface can be returned (blown back) into the drying chamber 22.

In addition, since the air is circulated in a manner that the exhaust air is fed to the burning section 23 and the treating section 24 from the drying section 22 and then the hot air is again returned to the drying section 22, the pressure on the downstream side of the blow-back unit 60 becomes more negative, and accordingly, less amount of the remaining solvent vapor which could not removed by the blow-back unit 60 can be returned back into the drying section 22.

Furthermore, the portions near the air-knife nozzle 61, the printed paper inlet opening 32b and the printed paper outlet opening 45 are warmed so that the temperature of the hot air supplied into the treating section 24 through the pipe sections 80c and 80d as the hot air supply means and cleaned in the treating section 24 is maintained to a temperature more than the predetermined value, i.e., lower limit temperature for precipitation of the solvent vapor.

As mentioned above, by supplying the cleaned hot air to the portions near the air-knife nozzle 61 and the printed paper 1 which is conveyed, the temperatures at the portions near the printed paper inlet opening 32b and the printed paper outlet opening 45 can be maintained to temperatures more than the lower limit temperature for precipitation of the solvent vapor without cooling the air-knife nozzle 61 itself. Therefore, it is possible to prevent the precipitation of the solvent to the portions near the air-knife nozzle surface, the printed paper inlet opening 32b and the printed paper outlet opening 45.

The printed paper 1 is discharged out of the chamber 40 (chamber sections 40a, 40b), and thereafter, contacts the cooling roller 5 of the cooling device 4. According to such contacting, the ink on the printed paper 1 is rapidly cooled and fixed to the printed paper surface. In this cooling stage, since the solvent vapor have been fully removed from the surfaces of the printed paper 1, it is possible to prevent the solvent vapor from dewing on the surface of the cooling roller 5, and hence, the printed paper 1 and printed image described thereon are never contaminated with the solvent.

As mentioned hereinbefore, the ink drying device 20 of the web offset press is provided with the drying section 22 for drying the ink 1a adhering on the surface of the printed paper 1 in a manner that the ink 1a on the printed paper 1 is dried during the passing through the drying section 22. In such ink drying device 20, there is disposed the air-knife nozzle 61 for blowing back the solvent vapor remaining and staying around the printed paper surface into the drying section 22 by supplying the hot air to the portion near the outlet opening 45 of the drying section 22. Furthermore, the hot air supplied to the air-knife nozzle 61 is a cleaned exhaust air usable for the drying of the ink in the drying section 22. In addition, there is also arranged the control unit 90 as a temperature regulating means for regulating the temperature of the hot air to be supplied to the air-knife nozzle 61.

Furthermore, the ink drying device 20 is equipped with the inlet opening 32a for introducing the printed paper linto the drying section 22 and the outlet opening 45 for discharging the printed paper 1 outside the drying section and also provided with the pipe sections 80c and 80d for supplying the hot air so as to keep the portions near these inlet and outlet openings to provide the predetermined temperatures. In addition, these portions can be maintained to provide temperatures more than lower limit temperature of precipitation of the remaining solvent vapor staying around the printed paper surface by the hot air supplied through the pipe sections 80c and 80d.

Still furthermore, according to the drying device of the present invention, the air-knife nozzle 61 and the pipe sections 80c and 80d for supplying the hot air to the inlet and outlet openings 32a and 45 are covered by the chamber 40, into which the hot air is supplied.

According to the structural characters or arrangements of the present invention mentioned above, the solvent can be prevented from dewing in the next step, such as cooling step by the cooling device 4 as well as dewing on the surfaces of the mechanical structures of the device at the portions near the inlet and outlet openings 32a and 45, thus being possible to prevent the deterioration of the printing quality due to the adhering or sticking of the dewed solvent on the printed paper surface. In addition, by circulating a portion of the hit air, power or energy for generating the hot air can be economically reduced.

It is further noted that the present invention is not limited to the described embodiment and many other changes and modifications may be made without departing from the scopes of the appended claims.

The entire disclosure of Japanese Patent Application No. 2003-130706 filed on May 8, 2003 including the specification, claims, drawings and abstract is incorporated herein by reference in its entirety.

What is claimed is:

1. An ink drying device of an web offset press comprising:
a drying section for drying an ink adhering on a surface of a printed paper, in which the ink adhering on the printed paper surface is dried during passing through the drying section, said drying section being provided with an inlet through which the printed paper is guided into the drying section and an outlet through which the printed paper is discharged therefrom;
a hot air supply unit for supplying a hot air to a portion near the outlet of the drying section; and
a hot air blow-back unit for blowing back a solvent vapor remaining and staying around the printed paper surface into the drying section.

2. An ink drying device of an web offset press according to claim 1, further comprising a treating section, and wherein the hot air to be supplied to the blow-back unit is an exhaust air which is cleaned by the treating section after being used for drying the ink in the drying section.

3. An ink drying device of an web offset press according to claim 1, further comprising a temperature control unit for regulating a temperature of the hot air to be supplied to the blow-back unit.

4. An ink drying device of an web offset press according to claim 1, further comprising a hot air supply unit for supplying the hot air to portions near an inlet opening and an outlet opening provided for the ink drying device through which the printed paper introduced into and discharged from the drying section so as to keep temperatures at the portions near the inlet and outlet openings to a temperature more than a predetermined value.

5. An ink drying device of an web offset press according to claim 4, further comprising a chamber structure mounted to a wall structure of the ink drying device, and wherein the inlet of the drying section corresponds to the inlet opening provided for the ink drying device and the outlet opening is formed to the chamber structure so as to communicate with the outlet of the drying section formed to the wall structure of the ink drying device.

6. An ink drying device of an web offset press according to claim 4, wherein said hot air blow-back unit is disposed in the chamber structure.

7. Am ink drying device of an web offset press according to claim 6, wherein said hot air blow-back unit comprises an air-knife nozzle fixed to an inside of the chamber structure.

8. An ink drying device of an web offset press comprising:
a drying section for drying an ink adhering on a surface of a printed paper, in which the ink adhering on the printed paper surface is dried during passing through the drying section, said drying section being provided with an inlet through which the printed paper is guided into the drying section and an outlet through which the printed paper is discharged therefrom;
a burning section disposed above the drying section through a partition wall for generating a hot air for drying the printed paper;
a treating section disposed above the burning section through a partition wall for cleaning the hot air;
an inlet through which the printed paper is guided into the drying section;
an outlet through which the printed paper, which is dried in the drying section, is discharged therefrom;
a hot air supply unit for supplying the hot air to portions near the inlet and outlet for the printed paper so as to keep temperatures around the inlet and outlet to temperatures more than predetermined valves; and
a hot air blow-back unit for supplying the hot air at the portions near the inlet and outlet so as to blow back solvent vapor remaining and staying around the printed paper surface into the drying section, wherein the temperatures at the portions near the inlet and outlet is kept, by the hot air supplied by the hot air supply unit, to temperatures more than lower limit temperature for precipitation of the solvent vapor remaining and staying around the printed paper surface.
